(19) United States
(12) Patent Application Publication
(10) Pub. No.: US 2026/0192472 A1
(43) Pub. Date: Jul. 9, 2026

(54) ADJUSTABLE BREAD KNIFE

(71) Applicant: Wei Wei, Xiamen (CN)

(72) Inventor: Wei Wei, Xiamen (CN)

(21) Appl. No.: 19/022,150

(22) Filed: Jan. 15, 2025

(30) Foreign Application Priority Data
Jan. 9, 2025 (CN) 202520047094.1

(51) Int. Cl. B26B 29/06; B26B 5/00; B26B 9/02

(52) U.S. Cl. CPC B26B 29/063; B26B 5/00; B26B 9/02; B26B 2029/066

(57) ABSTRACT

An adjustable bread knife includes a knife holder, a blade and a locking assembly mounted on the knife holder. The knife holder is also provided with a movable baffle plate, the baffle plate can selectively move away from or move adjacent to the blade, thereby forming an adjustable interval, and the interval is configured to limit a thickness of the bread. The locking assembly can selectively lock or release the baffle plate. When the locking assembly releases the baffle plate, the baffle plate can selectively move away from or move adjacent to the blade, and when the baffle plate moves to a desired position, the locking assembly locks the baffle plate.

### CROSS-REFERENCE TO RELATED APPLICATIONS

The application claims priority of Chinese patent application CN2025200470941, filed on Jan. 9, 2025, which is incorporated herein by reference in its entirety.

### TECHNICAL FIELD

The present disclosure relates to the technical field of kitchenwares, in particular to an adjustable bread knife.

### BACKGROUND

In the prior art, there is a wide variety of tools for slicing bread. However, there are

still some technical defects or deficiencies. Although traditional bread knives are sharp in cutting, due to the lack of an effective thickness-adjusting device, users have to rely on manual control of the slice thickness during use. It is difficult to ensure the uniformity of the slices. Especially when cutting large-sized or soft-textured bread, it is more likely to result in inconsistent thickness. This not only affects the aesthetics of the slices but may also cause inconvenience to subsequent processing.

Although some fixed-type bread slicing racks solve the problem of thickness uniformity in this embodiment through mold design, their structures are fixed and the thickness is non-adjustable, rendering them unable to meet various thickness requirements. In addition, such devices are usually large in size, which creates inconvenience for cleaning and storage, thus limiting their wide use in home scenarios in this embodiment.

### SUMMARY

In view of the above deficiencies, the present invention provides a bread knife in this embodiment. This bread knife can flexibly adjust the slice thickness without the need to change tools, and is applicable to different types of bread and thickness requirements. Meanwhile, this design features a simple structure and convenient operation, and employs easily-cleanable materials. It can significantly improve the accuracy and practicality of the slicing operation, thus solving the problems in the prior art, such as difficulty in controlling the thickness during bread-cutting, single-functionality, and inconvenience in use.

The technical solution adopted by the present invention to solve the technical problem is as follows.

An adjustable bread knife includes a knife holder, a blade mounted on the knife holder and a locking assembly.

The knife holder is also provided with a movable baffle plate, the baffle plate is able to selectively move away from or move adjacent to the blade, thereby forming an adjustable interval, and the interval is configured to limit a thickness of the bread; the locking assembly is able to selectively lock or release the baffle plate, when the locking assembly releases the baffle plate, the baffle plate is able to selectively move away from or move adjacent to the blade, and when the baffle plate moves to a desired position, the locking assembly locks the baffle plate.

As an improvement of the present invention, an adjustment area allowing movement of the baffle plate is arranged on the knife holder, and the baffle plate is able to move within the adjustment area and adjust a size of the interval.

As an improvement of the present invention, the adjustment area is a sliding groove, and the sliding groove is arranged on the knife holder and is located on one side of the blade.

As an improvement of the present invention, the baffle plate is provided with a sliding block extending into the sliding groove, and the sliding block is slidably connected to the sliding groove.

As an improvement of the present invention, the sliding block is arranged at each of two ends of the baffle plate, and each sliding block extends into the sliding groove and is slidably connected to the sliding groove.

As an improvement of the present invention, a width of the sliding block is less than that of the baffle plate.

As an improvement of the present invention, the knife holder is provided with a through slot; the locking assembly includes a locking rod movably arranged within the through slot and a clamping block connected to the locking rod; the through slot has at least two opposite slot openings, one of the slot openings penetrates through to the sliding groove and communicates with the sliding groove, the clamping block is located outside of the other slot opening, and a width of the clamping block is greater than that of the slot opening.

As an improvement of the present invention, the locking rod is a threaded rod.

As an improvement of the present invention, the sliding block is provided with a threaded hole, and the locking rod extends into the sliding groove and is in threaded connection with the threaded hole.

As an improvement of the present invention, the clamping block is provided with a knob, turning the knob can drive the locking rod to rotate, and a plurality of anti-slip projections are arranged on a sidewall of the knob.

As an improvement of the present invention, the locking rod and the threaded hole have a locked state and an unlocked state, when the locking rod and the threaded hole are in the locked state, the clamping block abuts against the two slot openings at both sides of the through slot, and the sliding block presses tightly against an inner wall surface of the sliding groove, thereby locking the baffle plate.

As an improvement of the present invention, when the locking rod and the threaded hole are in the unlocked state, the clamping block moves away from the two slot openings at both sides of the through slot, and the sliding block slides away from the inner wall surface of the sliding groove, thereby releasing the baffle plate.

As an improvement of the present invention, the slot opening at the other end of the through slot penetrates to a surface of the knife holder, the surface of the knife holder is provided with scales, and the scales are located on one side of the slot opening and are arranged along the slot opening from top to bottom.

As an improvement of the present invention, a top edge of the blade is a flat top edge, a cutting edge portion of the blade is located at a bottom edge of the blade, and the cutting edge portion is in a wavy shape.

As an improvement of the present invention, the knife holder is arc-shaped, and the knife holder is also provided with a grip.

As an improvement of the present invention, the grip is provided with a hanging portion for hooking the bread knife to an external item.

As an improvement of the present invention, the knife holder is provided with a movable area allowing the baffle to move, and the movable area has a mounting opening for mounting the blade.

As an improvement of the present invention, the knife holder includes a transverse bar, a first side bar and a second side bar located on both sides of the transverse bar, and the transverse bar, the first side bar and the second side bar enclose, forming the movable area.

As an improvement of the present invention, the sliding groove is on inner surfaces of the first side bar and the second side bar, and is arranged perpendicular to the mounting opening.

As an improvement of the present invention, the first side bar is provided with a first connection end, the second side bar is provided with a second connection end, the mounting opening is arranged between the first connection end and the second connection end, the blade is mounted within the mounting opening, and both ends of the blade are detachably connected to the first connection end and the second connection end respectively through connecting members.

The beneficial effects of the present invention are as follows. The adjustable bread knife provided by the present invention includes a knife holder and a blade mounted on the knife holder. The knife holder is also provided with a movable baffle plate. The baffle plate can selectively move away from or move adjacent to the blade, thereby forming an adjustable interval. The interval is configured to limit the thickness of the bread. It also includes a locking assembly. The locking assembly can selectively lock or release the baffle plate. When the locking assembly releases the baffle plate, the baffle plate can selectively move away from or move adjacent to the blade. When the baffle plate moves to the desired position, the locking assembly locks the baffle plate. Through the adjustable interval formed between the movable baffle plate and the blade, the slice thickness can be flexibly adjusted without the necessity of tool-changing, making it suitable for different types of bread and thickness requirements.

### BRIEF DESCRIPTION OF THE DRAWINGS

In order to explain the technical solutions of the embodiments of the present invention more clearly, the following will briefly introduce the accompanying drawings used in the embodiments. The drawings in the following description are only some embodiments of the present invention. Those of ordinary skill in the art can obtain other drawings based on these drawings without creative work.

The present invention is further described below in detail in combination with the accompanying drawings and embodiments.

FIG. 1 is a schematic diagram of an overall structure of the adjustable bread knife of the present invention;

FIG. 2 is an exploded view of the adjustable bread knife of the present invention;

FIG. 3 is an enlarged structural diagram of an area A in FIG. 1;

FIG. 4 is a schematic structural diagram of a locking assembly of the adjustable bread knife of the present invention;

FIG. 5 is an enlarged structural diagram of an area B in FIG. 2;

FIG. 6 is a schematic structural diagram of a knife holder of the adjustable bread knife of the present invention; and

FIG. 7 is a schematic diagram of an installation structure of a blade and the knife holder of the adjustable bread knife of the present invention.

### DETAILED DESCRIPTION OF THE EMBODIMENTS

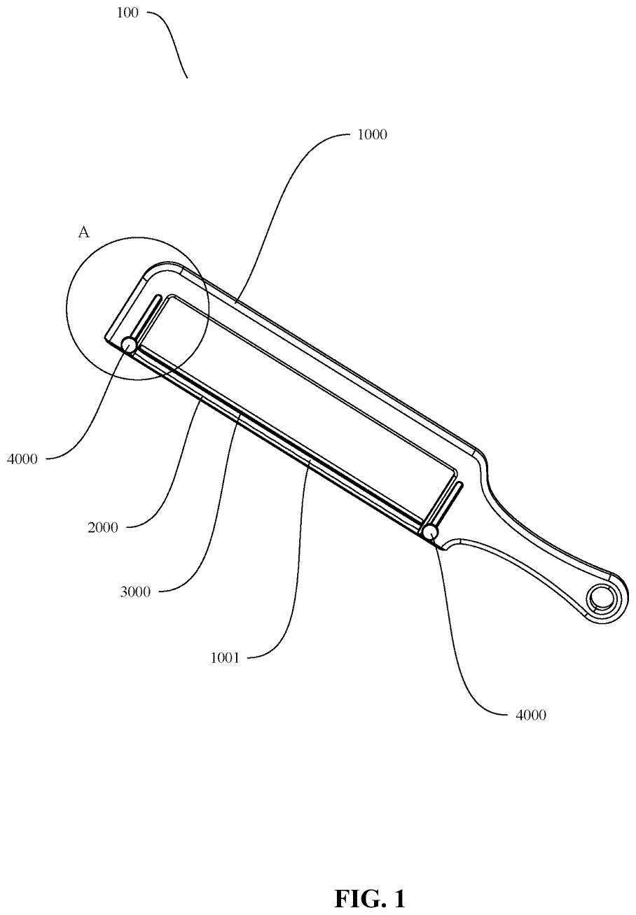

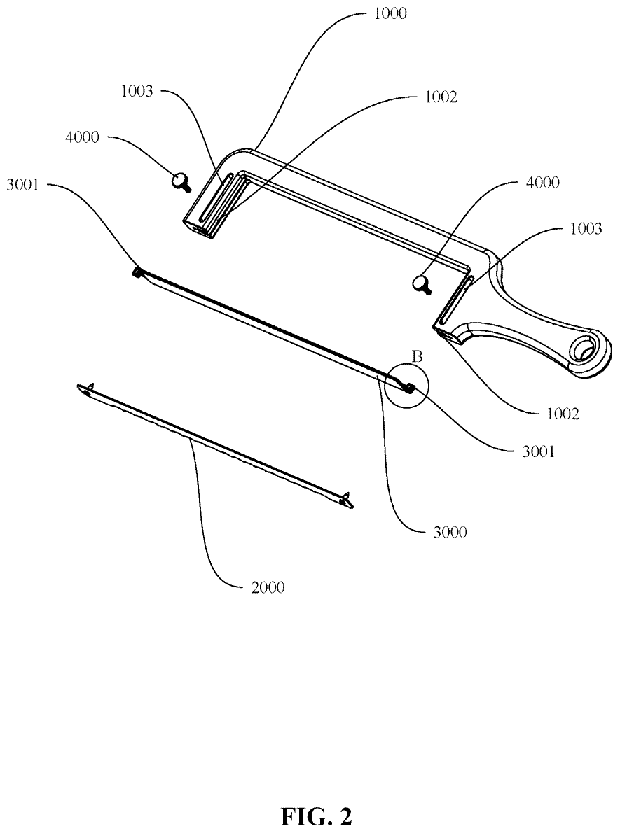

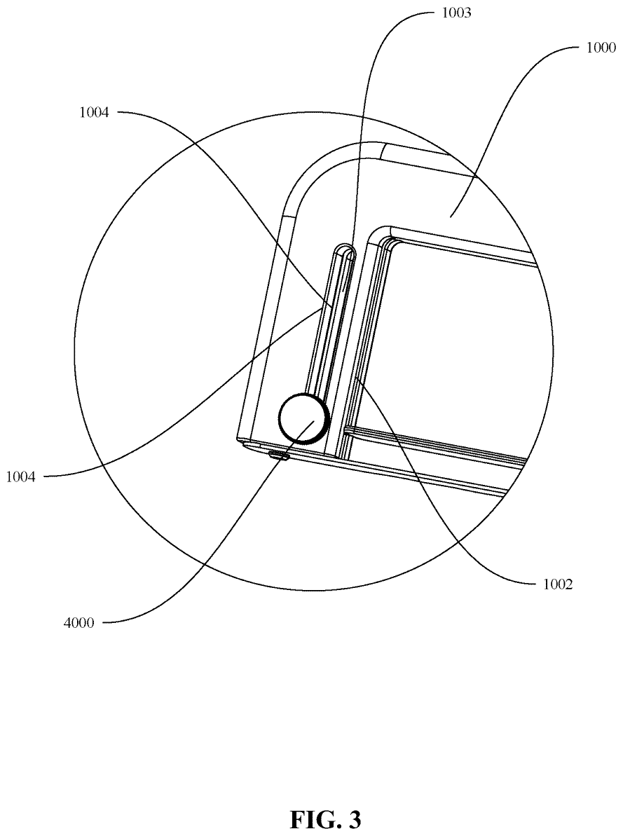

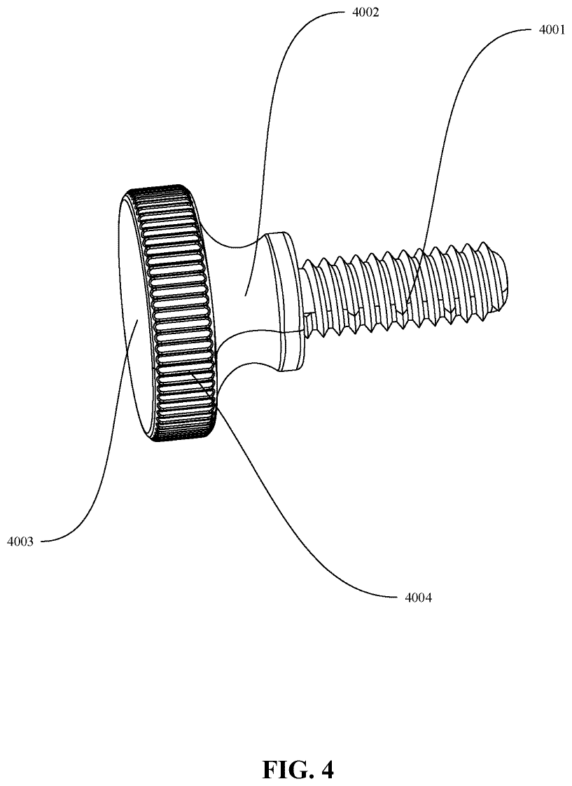

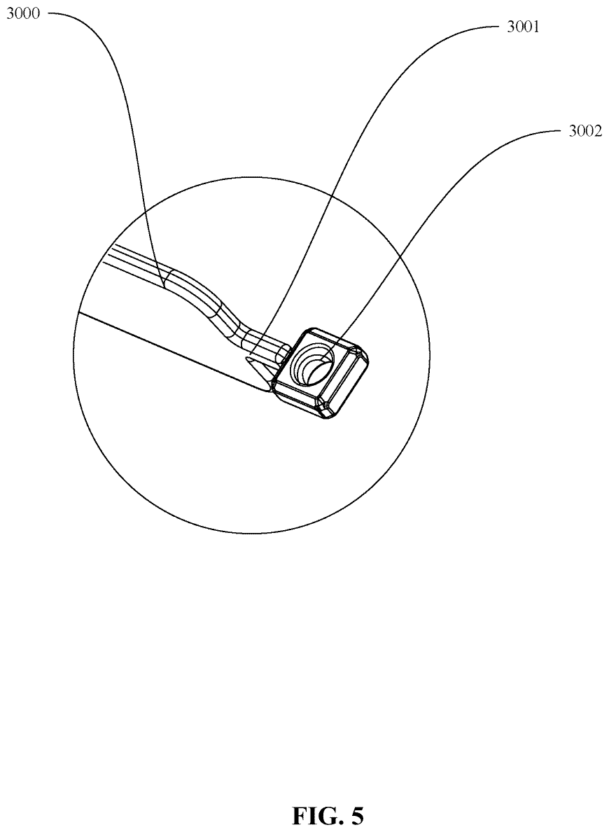

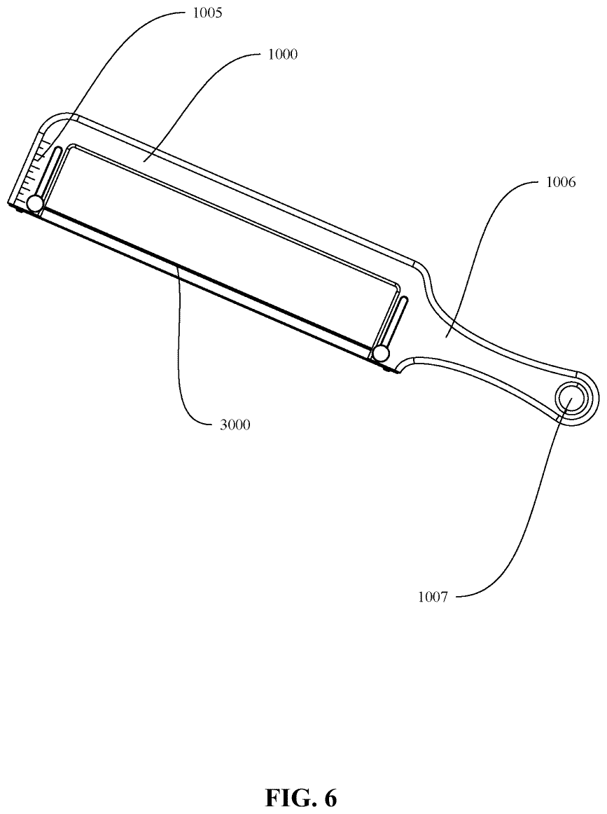

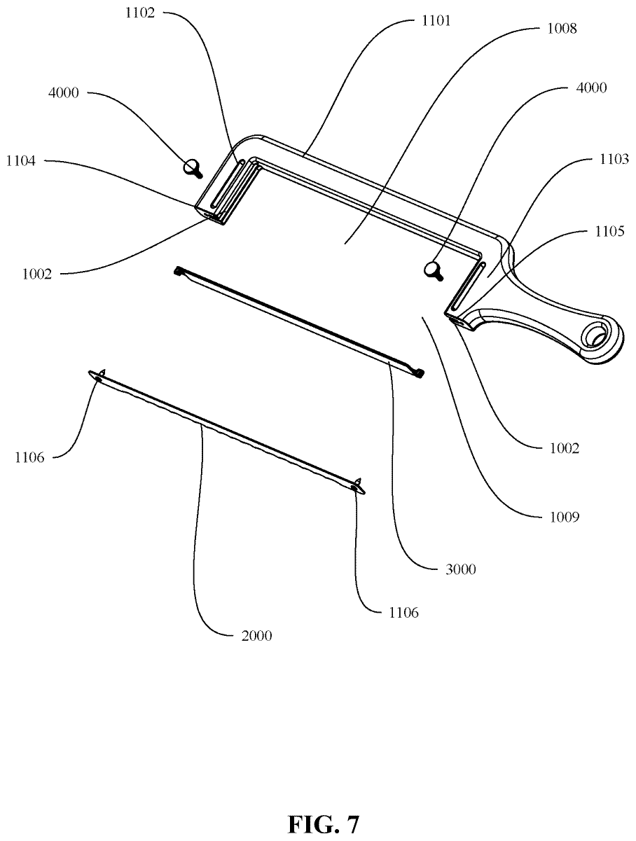

Referring to FIG. 1 to FIG. 7, the present invention provides an adjustable bread knife 100, which includes a knife holder 1000, a blade 2000 and a locking assembly 4000 mounted on the knife holder 1000. The knife holder 1000 is also provided with a movable baffle plate 3000, the baffle plate 3000 can selectively move away from or move adjacent to the blade 2000, thereby forming an adjustable interval 1001, and the interval 1001 is configured to limit a thickness of the bread. The locking assembly 4000 can selectively lock or release the baffle plate 3000. When the locking assembly 4000 releases the baffle plate 3000, the baffle plate 3000 can selectively move away from or move adjacent to the blade 2000, and when the baffle plate 3000 moves to a desired position, the locking assembly 4000 locks the baffle plate 3000.

Through the adjustable interval 1001 formed between the movable baffle plate 3000 and the blade 2000, the thickness of the bread can be adjusted as required, thus meeting different users'preferences for bread thickness. In addition, when the locking assembly 4000 releases the baffle plate 3000, the baffle plate 3000 can be adjusted to a direction that matches the user's left-handedness or right-handedness. Then, the locking assembly 4000 locks the baffle plate 3000 to accommodate the left-handed or right-handed habits of different users.

In this embodiment, an adjustment area allowing movement of the baffle plate 3000 is arranged on the knife holder 1000, and the baffle plate 3000 can move within the adjustment area and adjust a size of the interval 1001. When the baffle plate 3000 moves away from the blade 2000, the interval 1001 increases; when the baffle plate 3000 moves adjacent to the blade 2000, the interval 1001 decreases.

As a preference in this embodiment, the adjustment area is a sliding groove 1002, and the sliding groove 1002 is arranged on the knife holder 1000 and is located on one side of the blade 2000. Users only need to move the baffle plate 3000 through the sliding groove 1002 to quickly adjust the size of the interval 1001, improving the usability of the product in this embodiment.

In this embodiment, the baffle plate 3000 is provided with a sliding block 3001 extending into the sliding groove 1002, and the sliding block 3001 is slidably connected to the sliding groove 1002.

As a preference in this embodiment, the sliding block 3001 is arranged at each of two ends of the baffle plate 3000, and each sliding block 3001 extends into the sliding groove 1002 and is slidably connected to the sliding groove 1002. Arranging the sliding block 3001 at each of two ends of the baffle plate 3000 enables the baffle plate 3000 to move more smoothly within the sliding groove 1002, prevents wobbling or tilting caused by uneven force on one side in this embodiment, and enhances the overall structural stability of this embodiment.

As a preference in this embodiment, the width of the sliding block 3001 is less than that of the baffle plate 3000. The sliding block 3001 has a relatively small width, which enables the baffle plate 3000 to move more flexibly within the sliding groove. This enables more precise adjustment of the size of the interval 1001, thereby meeting the cutting requirements for different thicknesses.

In this embodiment, the knife holder 1000 is provided with a through slot 1003; the through slot 1003 has at least two opposite slot openings 1004, one of the slot openings 1004 penetrates through to the sliding groove 1002 and communicates with the sliding groove 1002.

In this embodiment, the locking assembly 4000 includes a locking rod 4001 movably arranged within the through slot 1003 and a clamping block 4002 connected to the locking rod 4001. The clamping block 4002 is located outside of the other slot opening 1004, and the width of the clamping block 4002 is greater than that of the slot opening 1004. The locking assembly 4000 is arranged within the through slot 1003. It can effectively fix the baffle plate 3000 within the sliding groove 1002, preventing loosening or displacement caused by vibration or other external forces during use. Moreover, in this embodiment, the width of the clamping block 4002 is greater than that of the slot opening 1004. This can prevent the clamping block 4002 from accidentally detaching from the through slot 1003, thereby improving the safety of use in this embodiment and avoiding potential risks in the operation of this embodiment.

As a preferred embodiment of the present invention, the locking rod 4001 is a threaded rod.

In this embodiment, the sliding block 3001 is provided with a threaded hole 3002, and the locking rod 4001 extends into the sliding groove 1002 and is in threaded connection with the threaded hole 3002. The threaded connection between the locking rod 4001 and the sliding block 3001 ensures that the baffle plate 3000 in this embodiment will not move easily after adjustment. This provides higher stability in this embodiment and effectively prevents loosening or displacement caused by vibrations or other external forces generated during use in this embodiment.

In this embodiment, the clamping block 4002 is provided with a knob 4003, turning the knob 4003 can drive the locking rod 4001 to rotate, and a plurality of anti-slip projections 4004 are arranged on a sidewall of the knob 4003. By arranging a knob 4003 on the clamping block 4002, users can directly turn the knob 4003 to drive the rotation of the locking rod 4001, making it more convenient and intuitive to adjust and lock the position of the baffle plate 3000. Moreover, the anti-slip projections 4004 enhance the user's grip during operation in this embodiment, reducing operational errors caused by slippery hands in this embodiment, thereby improving the safety and precision of the operation in this embodiment.

In this embodiment, the locking rod 4001 and the threaded hole 3002 have a locked state and an unlocked state. When the locking rod 4001 and the threaded hole 3002 are in the locked state, the clamping block 4002 abuts against the two slot openings 1004 at both sides of the through slot 1003, and the sliding block 3001 presses tightly against an inner wall surface of the sliding groove 1002, thereby locking the baffle plate 3000. When the locking rod 4001 and the threaded hole 3002 are in the unlocked state, the clamping block 4002 moves away from the two slot openings 1004 at both sides of the through slot 1003, and the sliding block 3001 slides away from the inner wall surface of the sliding groove 1002, thereby releasing the baffle plate 3000.

In this embodiment, the slot opening 1004 at the other end of the through slot 1003 penetrates to a surface of the knife holder 1000, the surface of the knife holder is provided with scales 1005, and the scales 1005 are located on one side of the slot opening 1004 and are arranged along the slot opening 1004 from top to bottom. This enables users to precisely adjust the position of the baffle plate 3000 according to the scales 1005, thereby accurately controlling the size of the interval 1001. As a preference in this embodiment, the measurement range of the scales 1005 is from 0 inches to 3 inches, and the measurement accuracy of the scales 1005 is 1/16 inch.

In this embodiment, a top edge of the blade 2000 is a flat top edge, a cutting edge portion of the blade 2000 is located at a bottom edge of the blade 2000, and the cutting edge portion is in a wavy shape. The wavy cutting edge can provide an additional serrated effect during cutting, enabling faster cutting speed. Especially when dealing with harder bread crusts, it can significantly improve cutting efficiency. As a preference in this embodiment, the blade 2000 is a stainless-steel blade. The stainless-steel blade has good oxidation resistance and rust-proof ability. Even when in contact with air and moisture for a long time, it is not prone to rusting. Moreover, the stainless-steel blade is more durable, maintains sharpness under high-intensity use, reduces wear and tear, and is easy to clean.

In this embodiment, the knife holder 1000 is arc-shaped, and the knife holder 1000 is also provided with a grip 1006. The grip 1006 is provided with a hanging portion 1007 for hooking the bread knife 100 to an external item. The hanging portion 1007 is provided on the grip 1006, allowing users to hang the bread knife 100 on a kitchen hook. This facilitates storage and retrieval, saves kitchen space in this embodiment, and keeps the workbench in this embodiment clean and tidy. As a preference in this embodiment, the knife holder 1000 is a bamboo-made knife holder. Bamboo has natural antibacterial and anti-mildew properties, which helps maintain the hygiene and safety of the knife holder. In addition, bamboo is a renewable resource, which is environmentally friendly. Moreover, the surface of the bamboo-made knife holder is smooth, making it easy to clean. It also has excellent durability, effectively extending the service life of the bread knife in this embodiment and providing users with a comfortable experience.

In this embodiment, the knife holder 1000 is provided with a movable area 1008 allowing the baffle 3000 to move, and the movable area 1008 has a mounting opening 1009 for mounting the blade 2000. The baffle 3000 can slide relative to the mounting opening 1009.

In this embodiment, the knife holder 1000 includes a transverse bar 1101, a first side bar 1102 and a second side bar 1103 located on both sides of the transverse bar 1101, and the transverse bar 1101, the first side bar 1102 and the second side bar 1103 enclose, forming the movable area 1008, which allows the baffle 3000 to slide relative to the mounting opening 1009, enabling users to adjust the position of the baffle more flexibly, thus better controlling the size of the interval 1001 to meet the cutting requirements of bread with different thicknesses.

In this embodiment, the grip 1006 is arranged on the second side bar 1103, and the width of the grip 1006 is less than that of the second side bar 1103.

In this embodiment, the sliding groove 1002 is on inner surfaces of the first side bar 1102 and the second side bar 1103, and is arranged perpendicular to the mounting opening 1009. By arranging the sliding groove 1002 on the inner surfaces of the first side bar 1102 and the second side bar 1103, users can more conveniently adjust the position of the baffle 3000.

In this embodiment, the first side bar 1102 is provided with a first connection end 1104, the second side bar 1103 is provided with a second connection end 1105, the mounting opening 1009 is arranged between the first connection end 1104 and the second connection end 1105, the blade 2000 is mounted within the mounting opening 1009, and both ends of the blade 2000 are detachably connected to the first connection end 1104 and the second connection end 1105 respectively through connecting members 1106. Both ends of the blade 2000 are detachably connected to the first connection end 1104 and the second connection end 1105 through the connecting members 1106. This enables users to easily disassemble and replace the blade, thereby extending the service life of the bread knife in this embodiment. Meanwhile, users can also adjust the direction of the cutting edge portion of the blade 2000 by removing the connecting members 1106 to accommodate the usage habits of left-handed or right-handed users.

As described above, one or more embodiments are provided in conjunction with the detailed description, The specific implementation of the present invention is not confirmed to be limited to that the description is similar to or similar to the method, the structure and the like of the present invention, or a plurality of technical deductions or substitutions are made on the premise of the conception of the present invention to be regarded as the protection of the present invention.

What is claimed is:

1. An adjustable bread knife, comprising:
a knife holder;
a blade mounted on the knife holder; and
a locking assembly,
wherein the knife holder is also provided with a movable baffle plate, the baffle plate is able to selectively move away from or move adjacent to the blade, thereby forming an adjustable interval, and the interval is configured to limit a thickness of the bread; the locking assembly is able to selectively lock or release the baffle plate, when the locking assembly releases the baffle plate, the baffle plate is able to selectively move away from or move adjacent to the blade, and when the baffle plate moves to a desired position, the locking assembly locks the baffle plate.

2. The adjustable bread knife according to claim 1, wherein an adjustment area allowing movement of the baffle plate is arranged on the knife holder, and the baffle plate is able to move within the adjustment area and adjust a size of the interval.

3. The adjustable bread knife according to claim 2, wherein the adjustment area is a sliding groove, and the sliding groove is arranged on the knife holder and is located on one side of the blade.

4. The adjustable bread knife according to claim 3, wherein the baffle plate is provided with a sliding block extending into the sliding groove, and the sliding block is slidably connected to the sliding groove.

5. The adjustable bread knife according to claim 3, wherein the sliding block is arranged at each of two ends of the baffle plate, and each sliding block extends into the sliding groove and is slidably connected to the sliding groove.

6. The adjustable bread knife according to claim 3, wherein a width of the sliding block is less than that of the baffle plate.

7. The adjustable bread knife according to claim 4, wherein the knife holder is provided with a through slot; the locking assembly comprises a locking rod movably arranged within the through slot and a clamping block connected to the locking rod; the through slot has at least two opposite slot openings, one of the slot openings penetrates through to the sliding groove and communicates with the sliding groove, the clamping block is located outside of the other slot opening, and a width of the clamping block is greater than that of the slot opening.

8. The adjustable bread knife according to claim 7, wherein the locking rod is a threaded rod.

9. The adjustable bread knife according to claim 8, wherein the sliding block is provided with a threaded hole, and the locking rod extends into the sliding groove and is in threaded connection with the threaded hole.

10. The adjustable bread knife according to claim 9, wherein the clamping block is provided with a knob, turning the knob can drive the locking rod to rotate, and a plurality of anti-slip projections are arranged on a sidewall of the knob.

11. The adjustable bread knife according to claim 10, wherein the locking rod and the threaded hole have a locked state and an unlocked state, when the locking rod and the threaded hole are in the locked state, the clamping block abuts against the two slot openings at both sides of the through slot, and the sliding block presses tightly against an inner wall surface of the sliding groove, thereby locking the baffle plate.

12. The adjustable bread knife according to claim 10, wherein when the locking rod and the threaded hole are in the unlocked state, the clamping block moves away from the two slot openings at both sides of the through slot, and the sliding block slides away from the inner wall surface of the sliding groove, thereby releasing the baffle plate.

13. The adjustable bread knife according to claim 7, wherein the slot opening at the other end of the through slot penetrates to a surface of the knife holder, the surface of the knife holder is provided with scales, and the scales are located on one side of the slot opening and are arranged along the slot opening from top to bottom.

14. The adjustable bread knife according to claim 1, wherein a top edge of the blade is a flat top edge, a cutting edge portion of the blade is located at a bottom edge of the blade, and the cutting edge portion is in a wavy shape.

15. The adjustable bread knife according to claim 1, wherein the knife holder is arc-shaped, and the knife holder is also provided with a grip.

16. The adjustable bread knife according to claim 15, wherein the grip is provided with a hanging portion for hooking the bread knife to an external item.

17. The adjustable bread knife according to claim 2, wherein the knife holder is provided with a movable area allowing the baffle to move, and the movable area has a mounting opening for mounting the blade.

18. The adjustable bread knife according to claim 17, wherein the knife holder comprises a transverse bar, a first side bar and a second side bar located on both sides of the transverse bar, and the transverse bar, the first side bar and the second side bar enclose, forming the movable area.

19. The adjustable bread knife according to claim 18, wherein the sliding groove is on inner surfaces of the first side bar and the second side bar, and is arranged perpendicular to the mounting opening.

20. The adjustable bread knife according to claim 19, wherein the first side bar is provided with a first connection end, the second side bar is provided with a second connection end, the mounting opening is arranged between the first connection end and the second connection end, the blade is mounted within the mounting opening, and both ends of the blade are detachably connected to the first connection end and the second connection end respectively through connecting members.
